(19) United States
(12) Patent Application Publication
(10) Pub. No.: US 2018/0335975 A1
(43) Pub. Date: Nov. 22, 2018

(54) TRANSLATING A HOST DATA STORAGE COMMAND INTO MULTIPLE DISK COMMANDS

(71) Applicant: Lenovo Enterprise Solutions (Singapore) Pte. Ltd., Singapore (SG)

(72) Inventors: David W. Cosby, Raleigh, NC (US); Theodore B. Vojnovich, Raleigh, NC (US); Michael N. Condict, Hurdle Mills, NC (US); Jonathan R. Hinkle, Raleigh, NC (US); Patrick L. Caporale, Cary, NC (US); Pravin Patel, Cary, NC (US)

(21) Appl. No.: 15/596,879

(22) Filed: May 16, 2017

(51) Int. Cl. G06F 3/06; G06F 12/1009; G06F 13/42

(52) U.S. Cl. CPC G06F 3/0659; G06F 3/0604; G06F 3/0661; G06F 3/0689; G06F 2213/0026; G06F 3/0688; G06F 13/4282; G06F 2212/65; G06F 12/1009

(57) ABSTRACT

An apparatus includes a memory device for storing program instructions and a processor for processing the program instructions to: receive a host data storage command that includes a host namespace, a host memory pointer and a logical block address range; translate the host data storage command into a plurality of disk data storage commands, wherein each disk data storage command is uniquely identified with a disk namespace on one of a plurality of non-volatile memory devices; and send, for each of the plurality of disk data storage commands, the disk data storage command to the non-volatile memory device that includes the uniquely identified disk namespace.

### BACKGROUND

The present disclosure relates to the storage of data on multiple non-volatile memory devices.

### BACKGROUND OF THE RELATED ART

A non-volatile memory (NVMe) device is a data storage unit that does maintains stored information even after a loss of power. Examples of non-volatile memory devices include hard disk drives, magnetic tape, optical disks, and flash memory. While non-volatile memory devices provide the benefit of providing persistent storage without consuming electricity, such non-volatile memory devices have historically been more expensive and have had lower performance and endurance than volatile random access memory. However, improvements in non-volatile memory devices are making them ever more competitive with volatile memory.

A physical NVMe drive may be connected to a host computer such that an application running on the host computer has a direct logical connection to the physical NVMe drive. Therefore, the application may directly access the physical NVMe drive using an NVMe namespace assigned to the drive. If there are multiple NVMe drives connected to the host computer, the application may access any one of the NVMe drives by using the namespace assigned to the respective NVMe drive.

### BRIEF SUMMARY

One embodiment provides an apparatus comprising a memory device for storing program instructions and a processor for processing the program instructions to: receive a host data storage command that includes a host namespace, a host memory pointer range and a logical block address range; translate the host data storage command into a plurality of disk data storage commands, wherein each disk data storage command is uniquely identified with a disk namespace on one of a plurality of non-volatile memory devices; and send, for each of the plurality of disk commands, the disk command to the non-volatile memory device that includes the uniquely identified disk namespace.

Another embodiment provides a computer program product comprising computer readable storage media that is not a transitory signal having program instructions embodied therewith, the program instructions executable by a processor to: receive a host data storage command that includes a host namespace, a host memory pointer range and a logical block address range; translate the host data storage command into a plurality of disk data storage commands, wherein each disk data storage command is uniquely identified with a disk namespace on one of a plurality of non-volatile memory devices; and send, for each of the plurality of disk data storage commands, the disk data storage command to the non-volatile memory device that includes the uniquely identified disk namespace.

Yet another embodiment provides a method comprising: receiving a host data storage command that includes a host namespace, a host memory pointer and a logical block address range; translating the host data storage command into a plurality of disk data storage commands, wherein each disk data storage command is uniquely identified with a disk namespace on one of a plurality of non-volatile memory devices; and sending, for each of the plurality of disk data storage commands, the disk data storage command to the non-volatile memory device that includes the uniquely identified disk namespace.

### BRIEF DESCRIPTION OF THE SEVERAL VIEWS OF THE DRAWINGS

FIG. 1A is a diagram illustrating how abstraction changes a host server view of multiple NVMe drives.

FIG. 1B is a diagram of the host namespace, host memory pointers and host LBA range fields of a PCIe frame from a host command being used to generate the PCIe frame of one or more disk commands to be directed to one or more individual NVMe drives.

FIG. 2 is a diagram of an apparatus for abstraction processing of the PCIe frames from the host.

FIG. 3 is a diagram illustrating two host namespaces and three physical NVMe drives divided into multiple disk namespaces.

FIG. 4 is a lookup table that identifies host namespaces and the disk namespaces allocated to each host namespace.

FIG. 5 is a diagram illustrating a single host command that is translated into multiple disk commands.

FIG. 6 is a diagram illustrating an example of a host command that references an LBA range that maps to a contiguous portion of a single disk namespace such that only a single disk command is generated.

FIG. 7 is a diagram illustrating an example of a host command that references an LBA range that maps to multiple disk namespaces such that multiple disk commands are generated.

FIG. 8 is a diagram of a computer that may perform abstraction services.

### DETAILED DESCRIPTION

One embodiment provides an apparatus comprising a memory device for storing program instructions and a processor for processing the program instructions to: receive a host data storage command that includes a host namespace, a host memory pointer range and a logical block address range; translate the host data storage command into a plurality of disk data storage commands, wherein each disk data storage command is uniquely identified with a disk namespace on one of a plurality of non-volatile memory devices; and send, for each of the plurality of disk commands, the disk command to the non-volatile memory device that includes the uniquely identified disk namespace. It should be recognized that the memory device may include multiple memory devices operating together to store the program instructions. It should also be recognized that the processor may include multiple processors operating together to process the program instructions.

In any given NVMe data storage system, an administrator may select any number of NVMe disks and select any slice size, most preferably during an initial configuration of the NVMe disks or abstraction service. The size (storage capacity) of a slice and the size of an LBA (i.e., a number of bytes, etc.) will determine the number of LBAs in a slice. Along with configuring the NVMe data storage system, the size of a slice, the size of an LBA and the number of LBAs in a slice are preferably fixed. A “slice” is a designated amount or portion of an NVMe drive. For example, a 1 TB NVMe drive might be divided up into 1000 slices, where each slice includes 1 GB of data storage. The terms NVMe disk, NVMe drive and NVMe device are used interchangeable with no distinction intended. Furthermore, the term NVMe disk does not imply any particular shape and the term NVMe drive does not imply any moving parts. One example of an NVMe disk or drive is a flash memory device, such as memory devices based on NAND or NOR logic gates.

A host namespace (or host volume) is automatically or manually mapped to one or more disk namespaces (i.e., one or more disk slices), perhaps during the initial configuration of the physical NVMe drives. There is no set limit on the number of host namespaces or disk namespaces. In one embodiment, the mapping of each host namespace to one or more disk namespaces may take the form of a lookup table. For example, the lookup table may include one or more records (rows), where each record includes a first field identifying a host namespace and a second field identifying each of the disk namespaces that have been allocated to the host namespace in the same record. The disk namespaces within a record are preferably listed in a fixed order, such that the disk namespaces may be further referenced by an ordinal number (i.e., 1^{st}, 2^{nd}, 3^{rd}, 4^{th}, etc.). Accordingly, any number of disk namespaces from any combination of the physical disks may be allocated to a host namespace without any requirement that the disk namespaces be contiguous on a given disk or even contiguous within a given stripe of disk slices. Furthermore, since the physical NVMe drives are abstracted from the host view, it is possible to add, remove or replace physical NVMe drives without changing the host view.

The abstraction of the physical NVMe drives may be performed by the host or by a separate apparatus. For example, the host may perform the abstraction using one or more processor to execute program instructions stored in memory. Alternatively, a separate apparatus may include one or more processors disposed between the host and the NVMe drives in order to perform the abstraction by translating the host data storage command into one or more disk data storage commands and coalescing a single response from one or more corresponding disk responses. The apparatus may further include instruction memory buffers and lookup tables operatively coupled to the one or more processors. Optionally, the apparatus may be an external apparatus that is operatively coupled between the host and a plurality of NVMe drives.

A host computer, such as a host server, may generate a host data storage command (or simple “host command”) that describes a desired data transaction, such as a transaction to read data from data storage or a transaction to write data to data storage. Specifically, an application program running on the host computer may generate a host data storage command to read or write data to storage. Optionally, the host data storage command may be generated with the assistance of an operating system. In either case, the host data storage command from the host computer may be, for example, in the form of a PCIe (Peripheral Component Interconnect Express) frame. PCIe is a high-speed serial computer expansion bus standard that encapsulates communications, such as host data storage commands, in packets. However, embodiments may implement other computer expansion bus standards.

PCIe is a layered protocol including a transaction layer, a data link layer and a physical layer. A PCIe frame includes a transaction layer packet, wherein the transaction layer packet includes, among other things, a namespace, a memory pointer range and an LBA (Logical Block Address) range. A host namespace represents a region of storage capacity that can be owned by one or more host servers or applications. Host memory pointers (or a host memory pointer range) identify a location of host memory that should be used for a given NVMe transaction, either to receive data (per a host READ command) or send data (per a host WRITE command). A Logical Block Address (LBA) range identifies the location of data on an NVMe drive that should be used for the given NVMe transaction, either to be transmitted into host memory (per a host READ) command) or to be received from host memory and stored on the drive (per a host WRITE command). When the host computer generates a host command directed to a host namespace, the disclosed embodiments use the data in the namespace field, memory pointers field and LBA range field in the host command to generate one or more disk data storage command (or simply “disk command”). Preferably, each disk data storage command is directed to only one disk namespace. In certain embodiments, one disk data storage command will be generated for every LBA in the LBA range of the host data storage command. In other words, a host data storage command with an LBA range including five LBAs may result in the generation of five disk data storage commands.

The host namespace (or host volume) in a host command may be used as an index into a lookup table that identifies one or more host namespaces. For each host namespace, the lookup table may identify one or more disk namespaces assigned to the host namespace. The disk namespaces within a given record of the lookup table are preferably listed in a fixed order, such that the disk namespaces may be further referenced by an ordinal number (i.e., 1^{st}, 2^{nd}, 3^{rd}4^{th}, etc.) regardless of the name given to the disk namespace. Accordingly, the host namespace in a host command may be uniquely associated with a specific set (sequence) of disk namespaces.

The host LBA range in the host command may be used to identify one or more specific disk namespace from among the set of one or more disk namespaces uniquely associated with the host namespace according to the lookup table. In addition, the host LBA range in the host command may also be used to identify one or more specific LBA on the identified disk namespace. Since the host namespace is uniquely associated with a certain ordered set of disk namespaces, and since each disk namespace includes a certain number of LBAs, the host LBA range can be mapped to the corresponding LBAs among the ordered set of disk namespaces. If the host LBA range maps to multiple disk namespaces, then it is preferable to generate a separate disk data storage command to each disk namespace, where each disk data storage command identifies a disk LBA range corresponding to a portion of the host LBA range. In various embodiments, the disk LBA range associated with each disk data storage command may be quickly calculated. Optionally, a disk data storage command with an LBA range of one LBA may be generated for every LBA in the LBA range of the host data storage command.

If the identified disk namespace is out of range (i.e., a disk namespace that is not allocated to the host namespace, for example a 5^{th} disk namespace where only 4 disk namespaces are allocated to the host namespace), then one of two outcomes may occur depending upon how the system has been configured. First, the system may be configured to automatically allocate one or more additional disk namespaces (slices) to the host namespace. For example, a host write command to an out-of-range disk namespace may be accomplished by allocating a sufficient number of additional disk namespaces so that the host write command may be performed. Any one or more of the additional disk namespaces may be allocated from the existing physical disks or from another physical disk that may be added. Second, the system may generate an error message to the host indicating that the host data storage command is out-of-range.

The host memory pointer range in the host data storage command describes where the host computing device stores data to be transferred to disk per a write command or where the host computing device will store data to be received from a disk per a read command. If the host data storage command is being abstracted and sent as multiple disk data storage commands to multiple disks, then each disk data storage command deals with only a portion of the host memory pointer range. However, the host memory pointer range associated with each disk data storage command may be quickly calculated according to various embodiments. In other words, the LBA range in each disk data storage command is mapped to a corresponding portion of the host memory pointer range.

As discussed above, a single host data storage command (i.e., “host queue entry” or “host IO”) may result in the generation of one or more disk data storage commands (i.e., “disk queue entries” or “disk IOs”). The number of disk data storage commands generated depends upon the degree to which the data referred to by the host command is spread across multiple disk namespaces. The host namespace, host memory pointer range and host LBA range in a single host data storage command are used to create each of the disk data storage commands. If the host command references an LBA range that maps to a contiguous portion of a single disk namespace, then it is possible to generate only a single disk data storage command for that contiguous LBA range. Alternatively, if the host data storage command references an LBA range that maps to multiple disk namespaces, then one embodiment will generate a disk data storage command for each LBA in the LBA range.

Embodiments may relieve the host computer from the complexity of separately managing each discrete physical NVMe drive. Rather, disclosed embodiments may divide the disk capacity into multiple disk namespaces, assign certain disk namespaces to a given host namespace, and achieve abstraction of the physical disks to enable various advanced storage services, such as the ability to grow or shrink the size of a drive (i.e., thin provisioning), the ability to move data content to optimal locations (i.e., FLASH Tiering and Data Protection such as RAID), the ability to manage the data content (i.e., take snapshots), and/or the ability to aggregate performance of all of the NVMe drives in a system (i.e., striping and load balancing). For example, the disclosed embodiments may implement thin provisioning by allocating further disk namespaces to a given host namespace as the host namespace needs more capacity or by reducing the disk namespaces allocated to a given host namespace if those disk namespaces are not being used. Furthermore, the disclosed embodiments may further implement striping by allocating, for a given host namespace, disk namespaces that are on separate physical disks. Load balancing may be implemented by migrating one or more disk namespace among the physical disks so that each physical disk is handling a similar load of input/output transactions, perhaps balancing total transactions, write transactions and/or read transactions. Still further, the disclosed embodiments may also implement various levels of a redundant array of independent disks (RAID) type of data storage system (i.e., providing data redundancy, performance improvement, etc.) by, for example, calculating and storing parity in a further disk namespace on a separate physical disk.

Embodiments may provide abstraction using various methodologies to transform the host data storage command into one or more corresponding disk data storage commands based upon the mapping of the host namespace to the various disk namespaces allocated to the host namespace. The host view may appear as though the host namespace is a single continuous physical disk, although the actual data storage space is distributed across multiple disk namespaces on multiple physical disks. The abstraction uses the host namespace, host memory pointer range, and LBA range from the host command to create the one or more disk (abstraction) data storage commands. The abstraction may be implemented using a lookup table and/or various logical and/or mathematical transforms, without limitation. For example, the fields of a disk data storage command may be generated from the fields of the host data storage command using Modulo math (i.e., using division of host data fields to produce a whole number quotient and a remainder that are used to generate the fields of the disk data storage command) as a mapping algorithm to abstract a range of LBAs. Alternatively, the fields of a disk data storage command may be generated from the host command using the upper LBA bits to select the first disk to use in a sequence of disk commands that send individual LBAs from the LBA range to each drive in a repeating sequence. Still further, a lookup table may be used to map each host namespace/host combination to a specific disk namespace/disk LBA combination.

Each disk that receives a disk data storage command may generate an abstraction response that may then be coalesced into a single host response that is responsive to the original host data storage command. As one example, a disk response to each disk write command may be a validation response (i.e., success or error). Accordingly, the host response may also be a validation response (i.e., success or error), where an error in any disk response will result in the host response indicating an error. For each disk read command, each disk response may include the requested data and the disk memory pointer range identifying the location in host memory where the requested data should be stored.

Another embodiment provides a computer program product comprising computer readable storage media that is not a transitory signal having program instructions embodied therewith, the program instructions executable by a processor to: receive a host data storage command that includes a host namespace, a host memory pointer range and a logical block address range; translate the host data storage command into a plurality of disk data storage commands, wherein each disk data storage command is uniquely identified with a disk namespace on one of a plurality of non-volatile memory devices; and send, for each of the plurality of disk data storage commands, the disk data storage command to the non-volatile memory device that includes the uniquely identified disk namespace. The foregoing computer program products may further include program instructions for implementing or initiating any one or more aspects of the apparatus or methods described herein.

Yet another embodiment provides a method comprising: receiving a host data storage command that includes a host namespace, a host memory pointer and a logical block address range; translating the host data storage command into a plurality of disk data storage commands, wherein each disk data storage command is uniquely identified with a disk namespace on one of a plurality of non-volatile memory devices; and sending, for each of the plurality of disk data storage commands, the disk data storage command to the non-volatile memory device that includes the uniquely identified disk namespace.

### Example 1

The following example, distributes Host LBAs across several disks with each disk having several slices. In other words, the embodiment would associate Host LBAs with the Disk LBAs beginning at Disk 0, slice 0 through Disk n, slice 0; then proceed to Disk 0, slice 1 through Disk n, slice 1; etc.

This Example assumes the following:
Number of Disks=4 Disks
Number of Slices per Disk=8 Slices
Size of a Disk Slice=12 LBAs
Size of LBA=4000 Bytes
Host memory location=44000 to 1579999
   (Memory Start Address=44000)

So, each disk has 96 LBAs (12*8) and the host can see 384 LBAs (4 disks*8 slices per disks*12 LBAs per slice). A Host Command including a reference to Host LBA 77 would be associated with a Disk Command including [Disk Namespace, Disk Slice Number, Disk LBA, Host Memory Starting Location, Host Memory Ending Location] determined as follows:

Disk Namespace
=REMAINDER (LBA #/Number of disks)
=REMAINDER (77/4)=1; Meaning Disk 1 or Disk NS 1
(note, if disk namespaces are abstracted, then “1” would be used to look up the actual disk and/or namespace)

Disk Slice Number
=QUOTIENT (LBA #/(size of slice*number of disks))
=QUOTIENT (77/(12*4))=1; Meaning Disk Slice #1

Disk LBA
=QUOTIENT (LBA #/number of disks)−(disk Slice Number*Size of Slice)
=QUOTIENT (77/4)−(1*12)=7; Meaning Disk LBA of 7

Host Memory Starting Location
=Memory Start Address+LBA # *Size of LBA
=44000+77*4000=352000

Host Memory Ending Location
=Host Memory Starting Location+size of LBA−1
=352000+4000−1=355999
(Note that the Host Memory Starting Location is calculated in the above calculation for the given Host LBA, and is not the same as the Memory Start Address)

So, a read or write to Host LBA 77, would be to Disk 1, Slice 1, LBA 7 and would be placed into (for reads) or retrieved from (for writes) host memory location 352000 thru 355999.)

The following is a non-limiting example of computer code in the Python programming language for implementing an embodiment as in Example 1.

#divmod(numerator, denominator) = result
#result[0] = Quotient result[1] = Remainder
#Example: divmod(5,2) → result[0] = 2 result[1] = 1
#e.g 2 * 2 = 4 + 1 =5
#Spraying across disks....disk 1 slice 1 lba 1...disk 2 slice 1 lba 1...3 1 1 ..4 1 1 ...1 1 2...2 1 2 ..etc

| | |
|---|---|
| for k in range(num_of_disks * disk_cap): | #set the number of host LBAs that can be supported per user |

input

| | |
|---|---|
| mydiskx = divmod(k,num_of_disks) | #for each LBA, get MOD and QUOTIENT to determine drive |
| mydisk = mydiskx[1] | #use QUOTIENT to identify target disk |
| myslicex = divmod(k,slice_size * num_of_disks) | #for each LBA, get MOD and QUOTIENT to determine slice |
| myslice = myslicex[0] | #use MOD to identify target slice |
| mytmplba = divmod(k,num_of_disks) | #for each LBA, get MOD and QUOTIENT |
| mylba = mytmplba[0] − myslice*slice_size | #target LBA = MOD(number of disks) − slice * size of slice |
| buf_start = mem_start + k*size_of_page | #Host mem buffer start and end address |

| buf_end = buf_start + size_of_page −1 | |
|---|---|
| stringtype = “Spray”.ljust(8,“ ”) | #print the trace entry |

string1 = “| H_NS:” + str(host_NS).rjust(3,“ ”) + “| | H_LBA:” + str(k).rjust(4,“ ”)
string2 = “| => | Disk:” + str(mydisk).rjust(2,“ ”) + “| | D_NS:” + str(mypool3.disk_NS[mydisk]).rjust(3,“ ”)
string3 = “| | D_Slice:” + str(myslice).rjust(3,“ ”)
string4 = “| | D_LBA:” + str(mylba).rjust(4,“ ”)
string5 = “| | H_Buffer:” + str(buf_start).rjust(8,“ ”)
string6 = “ ::” + str(buf_end).rjust(8,“ ”)+ “|”
slice_index = mypool3.DP_Lookup_Slice(mydisk,myslice) #check that specific drive location can be RD/WR per
mypool3.DP_Load_Location(mydisk, slice_index, mylba,k) #calculated abstration parameters
print(stringtype+string1+string2+string3+string4+string5+string6)

### Example 2

This example places Host LBAs sequentially on several disks with each disk having several slices. In other words, the embodiment would associate Host LBAs with the Disk LBAs beginning at Disk 0, slice 0 through Disk 0, slice n; then proceed to Disk 1, slice 0 through Disk 1, slice n; etc.

This Example assumes the following:
Number of Disks=4 Disks
Number of Slices per Disk=8 Slices
Size of a Disk Slice=12 LBAs
Size of LBA=4000 Bytes
Host memory location=44000 to 1579999
   (Memory Start Address=44000)

So, each disk has 96 LBAs (12*8) and the host can see 384 LBAs (4 disks*8 slices per disks*12 LBAs per slice). A Host Command including a reference to Host LBA 77 would be associated with a Disk Command including [Disk Namespace, Disk Slice Number, Disk LBA, Host Memory Starting Location, Host Memory Ending Location] determined as follows:

Disk Namespace
=QUOTIENT (QUOTIENT (LBA #/Size of Slice)/number of slices)
=QUOTIENT (QUOTIENT (77/12)/8)=0; Meaning Disk 0 or Disk NS 0
(note, if disk namespaces are abstracted, then “0” would be used to look up the actual disk and/or namespace)

Disk Slice Number
=REMAINDER (QUOTIENT (LBA #/size of slice)/number of slices)
=REMAINDER (QUOTIENT (77/12)/8)=6; Meaning Disk Slice #6

Disk LBA
=REMAINDER (LBA #/size of slice)
=REMAINDER (77/12)=5; Meaning Disk LBA of 5

Host Memory Starting Location
=Memory Start Address+LBA # *Size of LBA
=44000+77*4000=352000

Host Memory Ending Location
=Host Memory Starting Location+size of LBA−1
=352000+4000−1=355999
(Note that the Host Memory Starting Location is calculated in the above calculation for the given Host LBA, and is not the same as the Memory Start Address)

So a read or write to Host LBA 77, would be to Disk 0, Slice 6, LBA 5 and would be placed into (for reads) or retrieved from (for writes) host memory location 352000 thru 355999. The following is a non-limiting example of computer code in the Python programming language for implementing an embodiment as in Example 2.

#concatenating disks....disk 1 slices 1 thru n...disk 2 slices 1 thru n...etc
for k in range(num_of_disks * disk_cap):

| myslicex = divmod(k,slice_size) | # my slice 0 = disk my slice 1 = slice |
|---|---|
| myslicey = divmod(myslicex[0],num_of_slices) | #MOD(MOD(slice size) by number of slices) |
| mydisk = myslicey[0] | #MOD identifies the target disk |
| myslice = myslicey[1] | #QUOTIENT identifies the target slice on that disk |
| mytmplba = divmod(k,slice_size) | |
| mylba = mytmplba[1] | #QUOTIENT identifies the target LBA |

| buf_start = mem_start + k*size_of_page | |
|---|---|
| buf_end = buf_start + size_of_page −1 | |
| stringtype = “Concat”.ljust(8,“ ”) | #print trace entry |

string1 = “| H_NS:” + str(host_NS).rjust(3,“ ”) + “ | | H_LBA:” + str(k).rjust(4,“ ”)
string2 = “| => | Disk:” + str(mydisk).rjust(2,“ ”) + “| | D_NS:” + str(mypool3.disk_NS[mydisk]).rjust(3,“ ”)
string3 = “| | D_Slice:” + str(myslice).rjust(3,“ ”)
string4 = “| | D_LBA:” + str(mylba).rjust(4,“ ”)
string5 = “| | H_Buffer:” + str(buf_start).rjust(8,“ ”)
string6 = “ ::” + str(buf_end).rjust(8,“ ”) + “|”
slice_index = mypool3.DP_Lookup_Slice(mydisk,myslice)
mypool3.DP_Load_Location(mydisk, slice_index, mylba,k)
print(stringtype+string1+string2+string3+string4+string5+string6)

| | |
|---|---|
| for q in range(mypool3.num_of_disks): | # displays all the disks in the pool |

mypool3.DP_Display_Disk(q)

### Example 3

In the following example, assume that there are three host namespaces (HNS 101, HNS 102 and HNS 103); three physical NVMe disks/drives (disk namespaces DNS 0, DNS 1 and DNS 2) that are each divided into a number of 9 disk slices (i.e., DS 0 through DS 8), where each slice has 8 disk LBAs (DLBA 1 through DLBA 8) of the same size (500 bytes). In this example, data from each host namespace is distributed (striped) across the three disks at the LBA-level, with one LBA per disk, then repeat until reaching the end of a disk slice, and continue with the next disk slice if needed. As in the above examples, the function QUOTIENT returns a whole number integer value resulting from dividing two integers, and the function REMAINDER (or MOD) returns the remainder of dividing two integers. Fields of a disk data storage command are then generated for each LBA in the LBA range of a host data storage command. A host data storage command may include fields for a host namespace, a host memory pointer range (defining a starting memory pointer/address and an ending memory pointer/address), and a logical block address range (defining a first LBA and a last LBA). These fields are used as the input, along with the fixed parameters set out above in this example, that facilitates generation of the fields in each of the resulting disk data storage commands.

For this non-limiting example, a host data storage command includes HNS 101, Host LBA start 5, Host LBA end 45, Host Mem. Ptr. start 30000, and Host Mem. Ptr end 79999. Table 1 shows all of the disk data storage commands (i.e., for each subsequent Host LBA) that would be generated in this example:

TABLE 1
Translation of the Host Data Storage Command

| Host LBA | | | Disk Data Storage Command (fields) | | | |
|---|---|---|---|---|---|---|
| HNS: 101 | HLBA: 005 | => | DNS: 002 | DS: 000 | DLBA: 001 | MEM: 030000-030499 |
| HNS: 101 | HLBA: 006 | => | DNS: 000 | DS: 000 | DLBA: 002 | MEM: 030500-030999 |
| HNS: 101 | HLBA: 007 | => | DNS: 001 | DS: 000 | DLBA: 002 | MEM: 031000-031499 |
| HNS: 101 | HLBA: 008 | => | DNS: 002 | DS: 000 | DLBA: 002 | MEM: 031500-031999 |
| HNS: 101 | HLBA: 009 | => | DNS: 000 | DS: 000 | DLBA: 003 | MEM: 032000-032499 |
| HNS: 101 | HLBA: 010 | => | DNS: 001 | DS: 000 | DLBA: 003 | MEM: 032500-032999 |
| HNS: 101 | HLBA: 011 | => | DNS: 002 | DS: 000 | DLBA: 003 | MEM: 033000-033499 |
| HNS: 101 | HLBA: 012 | => | DNS: 000 | DS: 000 | DLBA: 004 | MEM: 033500-033999 |
| HNS: 101 | HLBA: 013 | => | DNS: 001 | DS: 000 | DLBA: 004 | MEM: 034000-034499 |
| HNS: 101 | HLBA: 014 | => | DNS: 002 | DS: 000 | DLBA: 004 | MEM: 034500-034999 |
| HNS: 101 | HLBA: 015 | => | DNS: 000 | DS: 000 | DLBA: 005 | MEM: 035000-035499 |
| HNS: 101 | HLBA: 016 | => | DNS: 001 | DS: 000 | DLBA: 005 | MEM: 035500-035999 |
| HNS: 101 | HLBA: 017 | => | DNS: 002 | DS: 000 | DLBA: 005 | MEM: 036000-036499 |
| HNS: 101 | HLBA: 018 | => | DNS: 000 | DS: 000 | DLBA: 006 | MEM: 036500-036999 |
| HNS: 101 | HLBA: 019 | => | DNS: 001 | DS: 000 | DLBA: 006 | MEM: 037000-037499 |
| HNS: 101 | HLBA: 020 | => | DNS: 002 | DS: 000 | DLBA: 006 | MEM: 037500-037999 |
| HNS: 101 | HLBA: 021 | => | DNS: 000 | DS: 000 | DLBA: 007 | MEM: 038000-038499 |
| HNS: 101 | HLBA: 022 | => | DNS: 001 | DS: 000 | DLBA: 007 | MEM: 038500-038999 |
| HNS: 101 | HLBA: 023 | => | DNS: 002 | DS: 000 | DLBA: 007 | MEM: 039000-039499 |
| HNS: 101 | HLBA: 024 | => | DNS: 000 | DS: 000 | DLBA: 008 | MEM: 039500-039999 |
| HNS: 101 | HLBA: 025 | => | DNS: 001 | DS: 000 | DLBA: 008 | MEM: 040000-040499 |
| HNS: 101 | HLBA: 026 | => | DNS: 002 | DS: 000 | DLBA: 008 | MEM: 040500-040999 |
| HNS: 101 | HLBA: 027 | => | DNS: 000 | DS: 001 | DLBA: 000 | MEM: 041000-041499 |
| HNS: 101 | HLBA: 028 | => | DNS: 001 | DS: 001 | DLBA: 000 | MEM: 041500-041999 |
| HNS: 101 | HLBA: 029 | => | DNS: 002 | DS: 001 | DLBA: 000 | MEM: 042000-042499 |
| HNS: 101 | HLBA: 030 | => | DNS: 000 | DS: 001 | DLBA: 001 | MEM: 042500-042999 |
| HNS: 101 | HLBA: 031 | => | DNS: 001 | DS: 001 | DLBA: 001 | MEM: 043000-043499 |
| HNS: 101 | HLBA: 032 | => | DNS: 002 | DS: 001 | DLBA: 001 | MEM: 043500-043999 |
| HNS: 101 | HLBA: 033 | => | DNS: 000 | DS: 001 | DLBA: 002 | MEM: 044000-044499 |
| HNS: 101 | HLBA: 034 | => | DNS: 001 | DS: 001 | DLBA: 002 | MEM: 044500-044999 |
| HNS: 101 | HLBA: 035 | => | DNS: 002 | DS: 001 | DLBA: 002 | MEM: 045000-045499 |
| HNS: 101 | HLBA: 036 | => | DNS: 000 | DS: 001 | DLBA: 003 | MEM: 045500-045999 |
| HNS: 101 | HLBA: 037 | => | DNS: 001 | DS: 001 | DLBA: 003 | MEM: 046000-046499 |
| HNS: 101 | HLBA: 038 | => | DNS: 002 | DS: 001 | DLBA: 003 | MEM: 046500-046999 |
| HNS: 101 | HLBA: 039 | => | DNS: 000 | DS: 001 | DLBA: 004 | MEM: 047000-047499 |
| HNS: 101 | HLBA: 040 | => | DNS: 001 | DS: 001 | DLBA: 004 | MEM: 047500-047999 |
| HNS: 101 | HLBA: 041 | => | DNS: 002 | DS: 001 | DLBA: 004 | MEM: 048000-048499 |
| HNS: 101 | HLBA: 042 | => | DNS: 000 | DS: 001 | DLBA: 005 | MEM: 048500-048999 |
| HNS: 101 | HLBA: 043 | => | DNS: 001 | DS: 001 | DLBA: 005 | MEM: 049000-049499 |
| HNS: 101 | HLBA: 044 | => | DNS: 002 | DS: 001 | DLBA: 005 | MEM: 049500-049999 |
| HNS: 101 | HLBA: 045 | => | DNS: 000 | DS: 001 | DLBA: 006 | MEM: 050000-050499 |

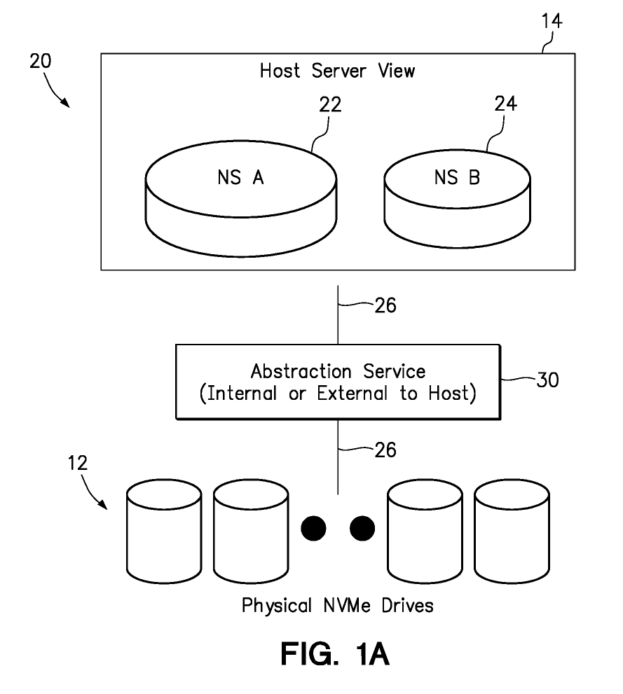

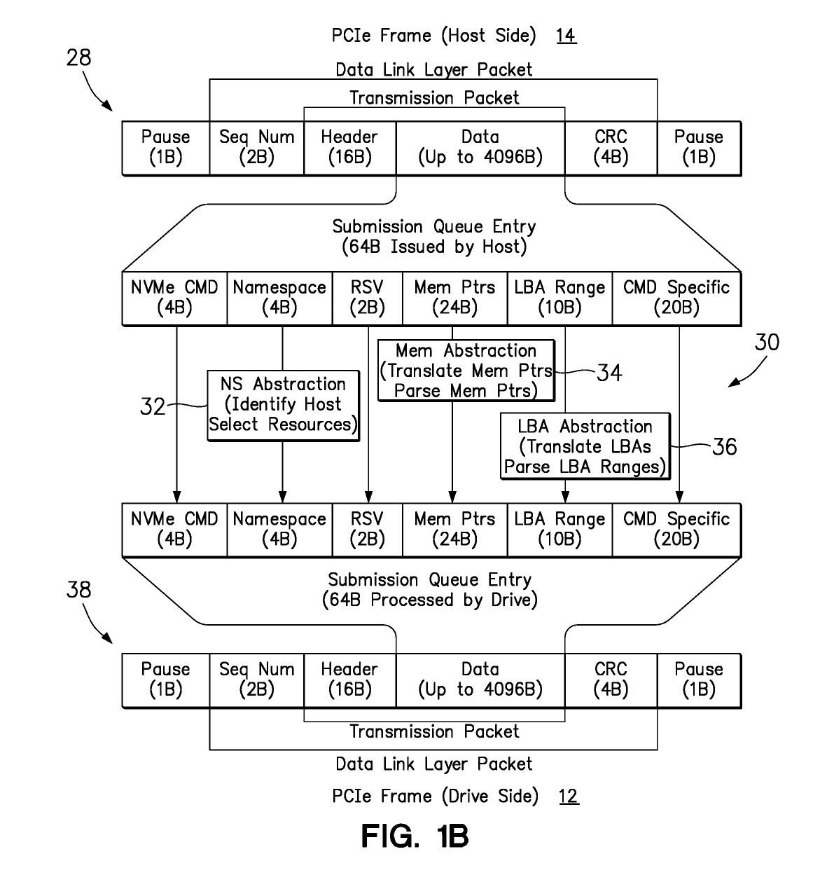

FIG. 1A is a diagram illustrating how an abstraction service 30 changes a host server view 20 of the multiple NVMe drives 12. The NVMe drives 12 are operatively coupled to the host server 14 by interconnections 26 that allows the host server 14 to perform read and write transactions with each of the NVMe drives 12. Note that the abstraction service 30 is disposed between the host server 14 and the physical NVMe drives 12 in order to abstract the drives 12 to the host server 14. Based upon an initial configuration, the host server view 20 illustrates that the host server 14 sees abstracted host namespaces 22, 24 (Namespace A and Namespace B) rather than seeing and managing each and every one of the physical NVMe drives 12. When the host server 14 generates an I/O (read or write) transaction (host command) for one of the host namespaces 22, 24, the abstraction service 30 translates the host command into one or more disk commands for one or more NVMe drive 12.

FIG. 1B is a diagram illustrating that the abstraction service 30 uses the namespace, memory pointers and LBA range fields of a PCIe frame 28 from a host command to generate an abstracted PCIe frame 38 of one or more disk commands to be directed to one or more individual NVMe drives 12. While other communication standards may be used, the PCIe frames 28, 38 follows a packetized bus protocol including a data link layer packet and a transmission packet (also referred to as a transaction layer packet). A namespace abstraction module 32 inspects the namespace field of the host PCIe frame (host command) 28, a memory pointer abstraction module 34 inspects the memory pointer field of the host PCIe frame (host command) 28, and an LBA abstraction module 36 inspects the LBA field of the host PCIe frame (host command) 28. Collectively, the modules 32, 34, 36 that form the abstraction service 30 generate a disk command to one or more of the NVMe drives 12. The abstraction service 30 may be either internal to the host 14 or external to the host 14, and the modules 32, 34, 36 that form the abstraction service 30 may be performed by a general purpose processor of the host 14 or by one of more dedicated processors.

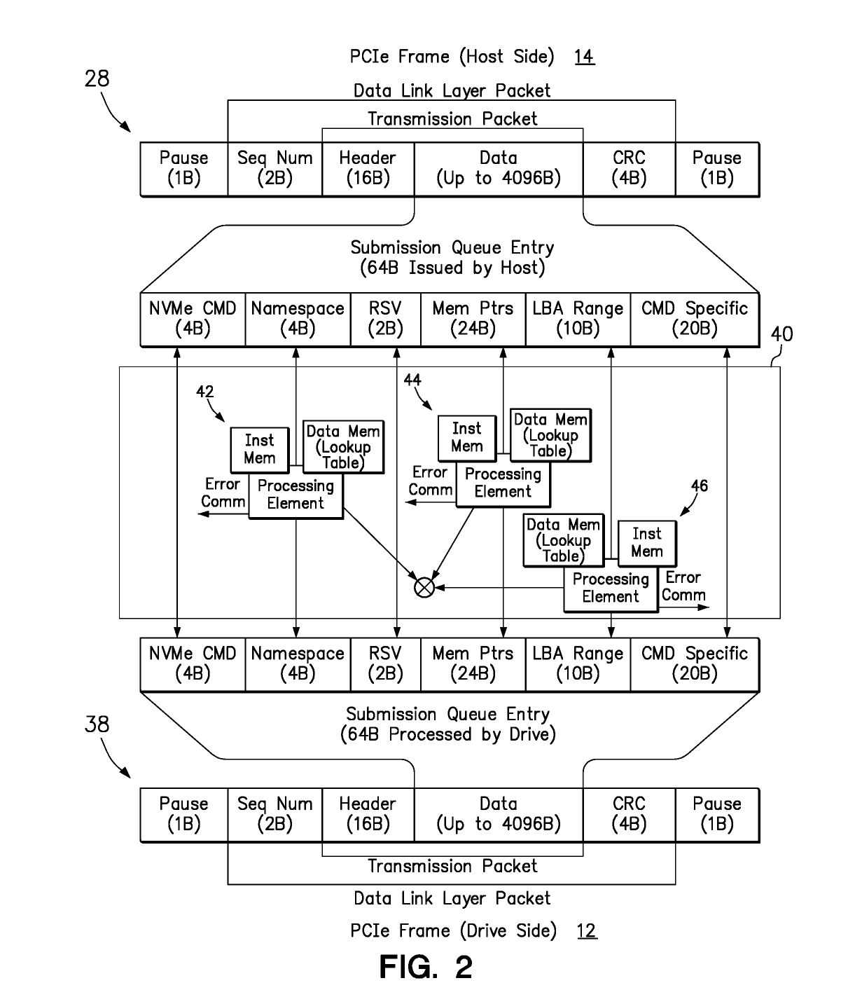

FIG. 2 is a diagram of an apparatus 40 for abstraction processing of the PCIe frame 28 of a host I/O command to generate one or more disk command including a PCIe frame 38. The apparatus 40 supports input/output with the host computer 14 and input/output with each of the physical NVMe drives 12. The apparatus 40 includes a namespace abstraction hardware module 42 that inspects the namespace field of the host PCIe frame (host command) 28, a memory pointer abstraction hardware module 44 that inspects the memory pointer field of the host PCIe frame (host command) 28, and an LBA abstraction hardware module 46 that inspects the LBA field of the host PCIe frame (host command) 28. In the embodiment shown, each module 42, 44, 46 includes a processing element, an instruction memory buffer and a programmable data memory. Accordingly, each module 42, 44, 46 may perform part of the host command translation and part of the response coalescing according to various embodiments. As shown, each processing unit may signal an error condition and communicate with other processing units to coordinate activities required to build disk commands. The programmable data memory may store program instructions, a lookup table and various parameters supporting the necessary calculations to be performed by the respective modules. Such parameters may, for example, include the number of disks, the number of LBAs per slice, the size of an LBA, and the like. The program instructions may vary depending upon the disk abstraction features, such as data striping, which are being implemented.

For example, the namespace abstraction hardware module 42 receives the namespace field of the host PCIe frame (host command) 28, and may access a lookup table in the programmable data memory in order to identify one or more disk namespace allocated to the host namespace. One or more host commands may be queued across instruction memory buffers for each field of the host command. The queue may include one or more host commands that waiting to be processed, one or more host commands that are currently being translated into disk commands, and one or more disk responses that are being coalesced into a host response.

The memory pointer abstraction hardware module 44 receives the memory pointer range field of a host PCIe frame (host command) 28, and generates memory pointer range field for each disk data storage command 38. For example, the memory pointer abstraction hardware module 44 may, to support calculation of a disk data storage command, receive a current host LBA number from an LBA abstraction hardware module 46.

The LBA abstraction hardware module 46 receives the LBA field of each host PCIe frame (host command) 28 and performs calculations that identify both the ordinal number of the namespace and the ordinal number of the LBA within the identified namespace. For example, the calculation of the ordinal number of the disk namespace may include taking the whole integer of the host LBA divided by the number of LBAs per disk namespace, then adding 1. Other calculations may be employed depending upon the abstraction being implemented. The ordinal number of the disk namespace may then be shared with the namespace abstraction hardware module 42, which identifies a disk namespace that is associated with the host namespace for the given host command and that is in the calculated ordinal position in the sequence of disk namespaces. The identified disk namespace is then used in the namespace field of the PCIe frame 38 that will be sent to the identified disk namespace. Similarly, the calculation of the ordinal number of the disk LBA may include taking the remainder of the host LBA divided by the number of LBAs per disk namespace. Accordingly, the ordinal number of the disk LBA is used in the LBA range field of the PCIe frame 38 that will be sent to the identified disk namespace when the disk command has been completed. Again, the exact details of calculations may vary depending upon the abstraction features being implemented. Furthermore, the processing may be distributed among the modules in any manner. Each module may have its own processor or multi-processor unit, but alternatively one or more modules may be performed one the same processor or multi-processor unit.

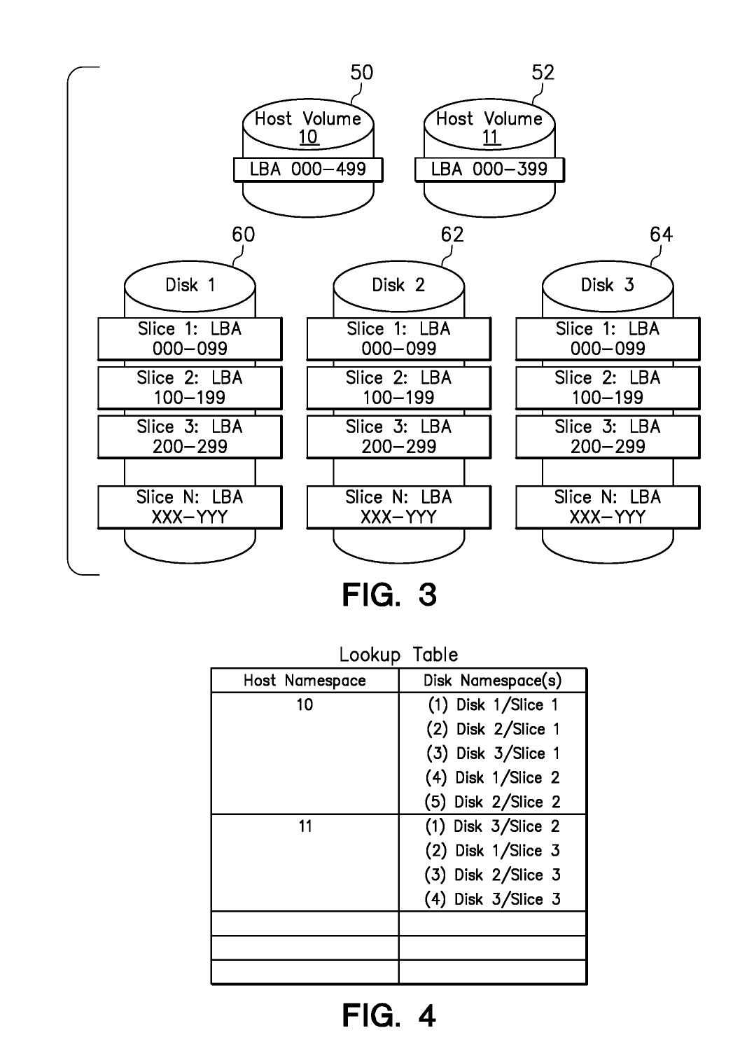

FIG. 3 is a diagram illustrating two host namespaces (host volume 10″ 50 and “host namespace 11” 52) and three physical NVMe drives (“disk 1” 60, “disk 2” 62 and “disk 3” 64). Each physical NVMe drive is divided into multiple slices (1 through N), wherein each slice has 100 LBAs and is given a disk namespace. In the example in FIG. 3, each disk namespace is a combination of the disk number and the slice number, such that “Slice 1” on “Disk 2” is referred to as disk namespace “Disk 2/Slice 1” or merely “2/1”.

FIG. 4 is a lookup table that identifies the two host namespaces (first column) and the disk namespaces (second column) allocated to each host namespace. In the lookup table, a disk namespace is shown to be allocate to, or associated with, a host namespace by virtue of being in the same record (row) of the table. As shown, the host namespace 10 has been allocated five disk namespaces (with 100 LBAs per namespace/slice). Specifically, the five disk namespaces are identified in a fixed order with their ordinal number in parenthesis. Similarly, host namespace 11 has been allocated four disk namespaces (with 100 LBAs per namespace/slice), which are also identified in a fixed order with their ordinal number in parenthesis. Accordingly, host namespace 10 has 500 LBAs, which are translated to the 500 LBAs in the five disk namespaces associated with the host namespace A. Similarly, host namespace 11 has 400 LBAs, which are translated to the 400 LBAs in the four disk namespaces associated with the host namespace 11. Additional host namespaces and their associated disk namespaces may be added to the lookup table as desired. Furthermore, if the host namespace 10 should run out of data storage space, it is possible to allocate a further disk namespace to the host namespace 10 merely by adding an available disk namespace as the next (6^{th}) disk namespace allocated to the host namespace 10.

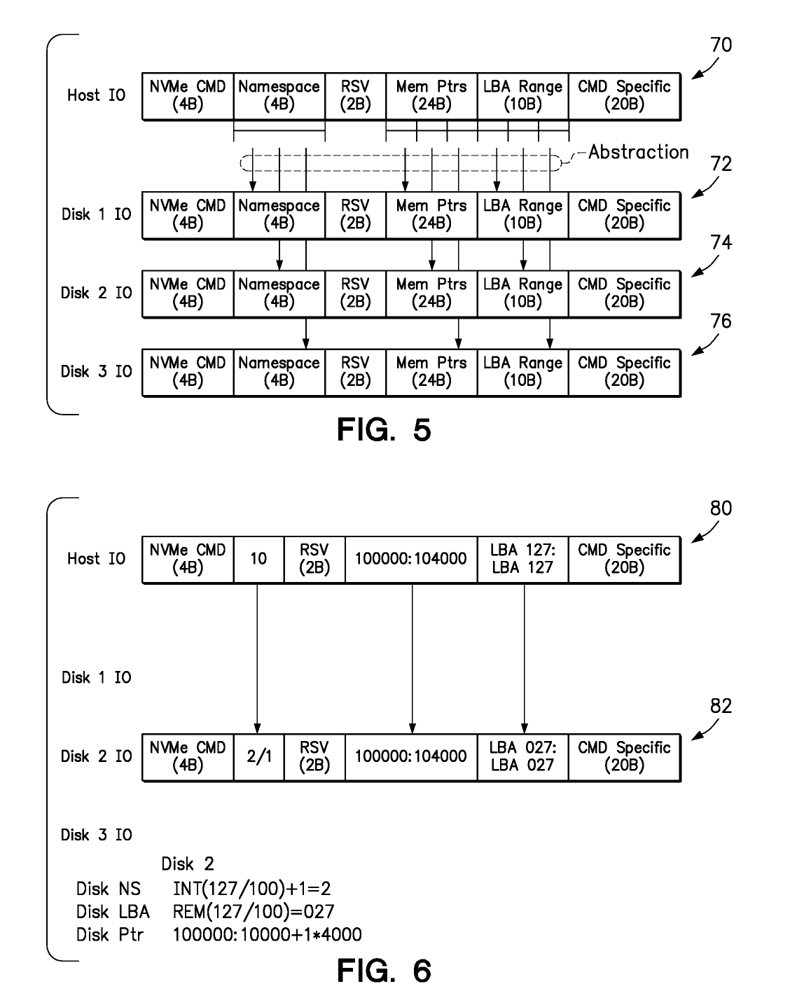

FIG. 5 is a diagram illustrating that a single host data storage command 70 may be translated into multiple disk data storage commands 72, 74, 76. The format of the command, such as a PCIe frame, remains the same for the host data storage command and the disk data storage commands, but the content of the namespace field, memory pointer field, and LBA range field will be modified specifically for each disk data storage command according to one or more embodiments of the abstraction.

FIG. 6 is a diagram illustrating an example of a host command 80 that references an LBA range that maps to a contiguous portion of a single disk namespace such that only a single disk command 82 is generated. The particular host command 80 is set out in the context of FIGS. 3 and 4, such that host namespace 10, LBA 127 maps to disk namespace 2/1 (disk 2/slice 1) and LBA 27 (i.e., LBA 27 is the starting and ending LBA). Furthermore, since the host command maps to a single disk namespace, the entire host memory pointer range 100000:104000 maps to the identified disk namespace.

$$Disk NS = INT ( 127 / 100 ) + 1 = 2 ( {2}^{nd} ordinal disk N S for “ host NS 10 ” )$$

$$Disk L B A = REM ( 127 / 100 ) = 27$$

$$\begin{matrix}Disk Mem . Ptr . Range = 100000 \text{:} 100000 + ( 1 L B A \times 4000 Bytes / LBA ) \\ = 100000 \text{:} 104000\end{matrix}$$

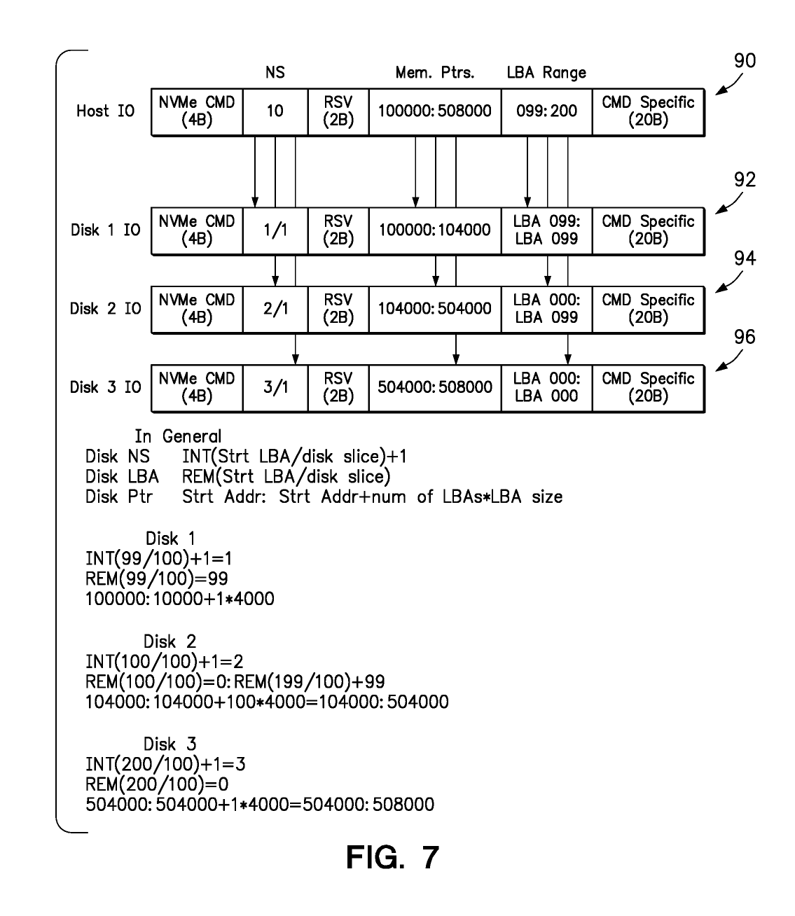

FIG. 7 is a diagram illustrating an example of a host command 90 that includes a host LBA range “099:200” that maps to multiple disk namespaces “1/1, 2/1, 3/1” such that three disk commands are generated. Notice that the lookup table in FIG. 4 includes a record for host namespace 10 which maps to disk names spaces, in order, (1) Disk 1/Slice 1, (2) Disk 2/Slice 1, (3) Disk 3/Slice 1, (4) Disk 1/Slice 2, and (5) Disk 2/Slice 2. Using the disk NS calculation, host LBA range 099:099 maps to disk namespace 1/1, LBA 099; host LBA range 100:199 maps to disk namespace 2/1, LBA 000:099; and host LBA range 200:200 maps to disk namespace 3/1, LBA 000:000. Similarly, the memory pointers are translated as shown in FIG. 7.

Disk NS=INT(Starting LBA #/# of LBAs per slice)+1

Disk LBA=REM(LBA #/# of LBAs per slice)

Disk Mem. Ptr. range=Strt Addr:Strt Addr+(# of LBAs×#Bytes/LBA)

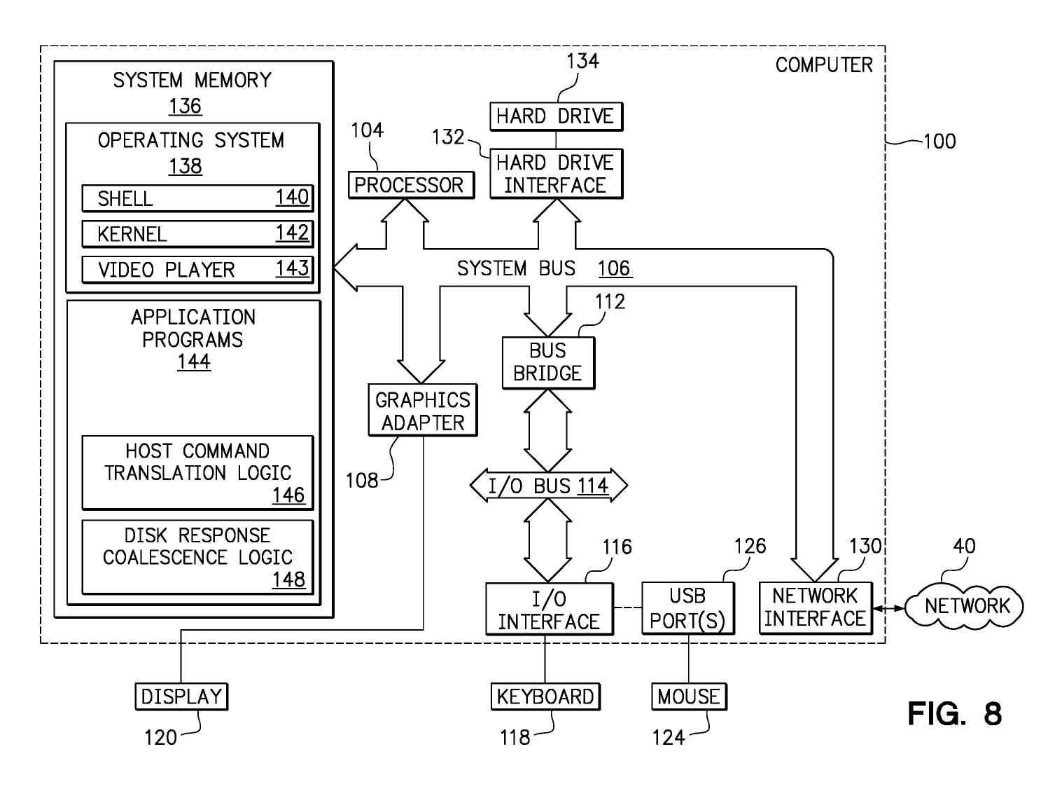

FIG. 8 is a diagram of a computer 100 that is representative of the host server 14 of FIG. 1 and non-limiting embodiments the abstraction service 30 of FIG. 1 or the apparatus 40 of FIG. 2. The computer 100 includes a processor unit 104 that is coupled to a system bus 106. The processor unit 104 may utilize one or more processors, each of which has one or more processor cores. A graphics adapter 108, which drives/supports a display 20, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, including a keyboard 18, and a USB mouse 24 (or other type of pointing device) via USB port(s) 126. As depicted, the computer 100 is able to communicate with other network devices over the network 40 using a network adapter or network interface controller 130.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 100. This volatile memory includes additional higher levels of volatile memory (not shown), including, but not limited to, cache memory, registers and buffers. Data that populates the system memory 136 includes the operating system (OS) 138 and application programs 144.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 may be a text-based, line-oriented user interface, the present invention may support other user interface modes, such as graphical, voice, gestural, etc.

As depicted, the operating system 138 also includes the kernel 142, which includes lower levels of functionality for the operating system 138, including providing essential services required by other parts of the operating system 138 and application programs 144. Such essential services may include memory management, process and task management, disk management, and mouse and keyboard management.

As shown, the computer 100 includes application programs 144 in the system memory of the computer 100, including, without limitation, host command translation (disk command generation) logic 146 and disk response coalescence logic 148 in order to implement one or more of the embodiments disclosed herein. Optionally, the logic 146, 148 may be included in the operating system 138.

The hardware elements depicted in the computer 100 are not intended to be exhaustive, but rather are representative. For instance, the computer 100 may include alternate memory storage devices such as magnetic cassettes, digital versatile disks (DVDs), Bernoulli cartridges, and the like. These and other variations are intended to be within the scope of the embodiments.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. An apparatus, comprising:
a memory device for storing program instructions; and
a processor for processing the program instructions to:
receive a host data storage command that includes a host namespace, a host memory pointer range and a logical block address range;
translate the host data storage command into a plurality of disk data storage commands, wherein each disk data storage command identifies with a disk namespace on one of a plurality of non-volatile memory devices; and
send, for each of the plurality of disk data storage commands, the disk data storage command to the non-volatile memory device that includes the uniquely identified disk namespace.

2. The apparatus of claim 1, the processor for further processing the program instructions to:
identify a plurality of disk namespaces allocated to the host namespace.

3. The apparatus of claim 2, wherein each disk namespace has the same number of logical block addresses.

4. The apparatus of claim 2, wherein the plurality of disk namespaces allocated to the host namespace are identified in a lookup table.

5. The apparatus of claim 3, the processor for further processing the program instructions to:
perform division of a first logical block address in the logical block address range by the number of logical block addresses in a disk namespace to a whole number quotient and a remainder, wherein the whole number quotient identifies an ordinal number of a disk namespace from among a fixed order of disk namespaces allocated to the host namespace, and wherein the remainder identifies a logical block address within the disk namespace.

6. The apparatus of claim 1, wherein each disk data storage command includes a disk memory pointer range that is a portion of the host memory pointer range.

7. The apparatus of claim 1, the processor for further processing the program instructions to:
receive, for each of the plurality of disk data storage commands, a response to the disk data storage command; and
coalesce the plurality of responses to the disk data storage commands into a single response to the host data storage command.

8. The apparatus of claim 1, wherein the host data storage command and the plurality of disk data storage commands are formatted according to a packetized bus protocol.

9. The apparatus of claim 1, the processor for further processing the program instructions to:
implement striping of data for the host namespace across the plurality of non-volatile memory devices.

10. A computer program product comprising computer readable storage media that is not a transitory signal having program instructions embodied therewith, the program instructions executable by a processor to:
receive a host data storage command that includes a host namespace, a host memory pointer and a logical block address range;
translate the host data storage command into a plurality of disk data storage commands, wherein each disk data storage command is uniquely identified with a disk namespace on one of a plurality of non-volatile memory devices; and
send, for each of the plurality of disk data storage commands, the disk data storage command to the non-volatile memory device that includes the uniquely identified disk namespace.

11. The computer program product of claim 10, wherein the program instructions are further executable by the processor to:
identify a plurality of disk namespaces allocated to the host namespace.

12. The computer program product of claim 11, wherein each disk namespace has the same number of logical block addresses.

13. The computer program product of claim 11, wherein the plurality of disk namespaces allocated to the host namespace are identified in a lookup table.

14. The computer program product of claim 12, wherein the program instructions are further executable by the processor to:
perform division of a first logical block address in the logical block address range by the number of logical block addresses in a disk namespace to a whole number quotient and a remainder, wherein the whole number quotient identifies an ordinal number of a disk namespace from among a fixed order of disk namespaces allocated to the host namespace, and wherein the remainder identifies a logical block address within the disk namespace.

15. The computer program product of claim 14, wherein each disk data storage command includes a disk memory pointer range that is a portion of the host memory pointer range.

16. The computer program product of claim 10, wherein the program instructions are further executable by the processor to:
receive, for each of the plurality of disk data storage commands, a response to the disk data storage command;
coalesce the plurality of responses into a single response to the host data storage command.

17. The computer program product of claim 10, wherein the host data storage command and the disk data storage commands are formatted according to a packetized bus protocol.

18. The computer program product of claim 10, wherein the program instructions are further executable by the processor to:
implement striping of data for the host namespace across the plurality of non-volatile memory devices.

19. A method, comprising:
receiving a host data storage command that includes a host namespace, a host memory pointer and a logical block address range;
translating the host data storage command into a plurality of disk data storage commands, wherein each disk data storage command is uniquely identified with a disk namespace on one of a plurality of non-volatile memory devices; and
sending, for each of the plurality of disk data storage commands, the disk data storage command to the non-volatile memory device that includes the uniquely identified disk namespace.

20. The method of claim 19, further comprising:
identifying a plurality of disk namespaces allocated to the host namespace.
